(19) United States
(12) Patent Application Publication
(10) Pub. No.: US 2001/0056476 A1
(43) Pub. Date: Dec. 27, 2001

(54) System and method for accessing a server connected to an IP network through a non-permanent connection

(75) Inventors: Alain Benayoun, Cagnes sur Mer (FR); Olivier Hericourt, Cagnes sur Mer (FR); Patrick Michel, La Gaude (FR); Jean-Francois Le Pennec, Nice (FR)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY (US)

(21) Appl. No.: 09/834,245

(22) Filed: Apr. 12, 2001

(30) Foreign Application Priority Data
Jun. 20, 2000 (EP) 00480052.0

(51) Int. Cl. G06F 15/16

(52) U.S. Cl. 709/218

(57) ABSTRACT

A method and system of accessing, from a client system connected to an Internet Protocol (IP) network, a server system connected to a Proxy server by means of a non-permanent connection through a circuit-switching network. The Proxy server can receive from the client system a request for accessing information located in the server system. The Proxy server identifies in the request the destination IP address of the server system. The Proxy server then determines the resource identifier of the server system in the circuit-switching network referring to a table. The table can include, for each server system identified by a destination IP address, a resource identifier in the circuit-switching network. A non-permanent connection with the server system is established using the resource identifier associated with the server system. The information requested by the client system is then retrieved from the server system and sent to the client system.

### TECHNICAL FIELD OF THE INVENTION

The present invention relates generally to computer networks, and more particularly to a system and method for accessing from a client connected to an IP (Internet Protocol) network, a server connected to a network providing non-permanent connections.

### BACKGROUND OF THE INVENTION

1.0 Internet

The Internet is a global network of computers and computers networks (the “Net”). The Internet connects computers that use a variety of different operating systems or languages, including UNIX, DOS, Windows, Macintosh, and others. To facilitate and allow the communication among these various systems and languages, the Internet uses a language referred to as TCP/IP (“Transmission Control Protocol/Internet Protocol”). The TCP/IP protocol supports three basic applications on the Internet:

1) transmitting and receiving electronic mail,

2) logging into remote computers (the “Telnet”), and

3) transferring files and programs from one computer to another (“FTP” or “File Transfer Protocol”).

1.1 TCP/IP

The TCP/IP protocol suite is named for two of the most important protocols: a Transmission Control Protocol (TCP), and an Internet Protocol (IP).

Another name for it is the Internet Protocol Suite. The more common term TCP/IP is used to refer to the entire protocol suite. The first design goal of TCP/IP is to build an interconnection of networks that provide universal communication services: an internetwork, or Internet. Each physical network has its own technology dependent communication interface, in the form of a programming interface that provides basic communication functions running between the physical network and the user applications. The architecture of the physical networks is hidden from the user. The second goal of TCP/IP is to interconnect different physical networks to form what appears to the user to be one large network.

TCP is a transport layer protocol providing end-to-end data transfer. It is responsible for providing a reliable exchange of information between two computer systems. Multiple applications can be supported simultaneously over one TCP connection between two computer systems.

IP is an internetwork layer protocol hiding the physical network architecture below it. Part of the communicating messages between computers is a routing function that ensures that messages will be correctly directed within the network to be delivered to their destination. IP provides this routing function. An IP message is called an IP Datagram.

Application Level protocols are used on top of TCP/IP to transfer user and application data from one origin computer system to one destination computer system. Such Application Level protocols are for instance File Transfer Protocol (FTP), Telnet, Gopher, and the Hyper Text Transfer Protocol (HTTP).

1.2 IP Router

A router interconnects networks at the internetwork layer level (IP) and routes messages between them. Routers are able to select the best transmission path between networks. The basic routing function is implemented in the IP layer of the TCP/IP protocol stack, so any host (or computer) or workstation running TCP/IP over more than one interface could, in theory, forward the messages between networks. However, dedicated network hardware devices called “Routers” provide more sophisticated routing functions than the minimum functions implemented in IP. Because IP implements the basic routing functions, the term “IP Router” is often used.

1.3 World Wide Web

With the increasing size and complexity of the Internet, tools have been developed to help find information on the network, often called navigators or navigation systems. Navigation systems that have been developed include standards such as Archie, Gopher and WAIS. The World Wide Web (“WWW” or “the Web”) is a recent navigation system offering significant advantages. Among other things, the Web provides: an Internet-based navigation system, an information distribution and management system for the Internet, and a dynamic format for communicating on the Web.

The Web seamlessly integrates different formats of information, including still images, text, audio and video. A user on the Web using a graphical user interface (“GUI”, pronounced “gooey”) may transparently communicate with different host computers on the system, and different system applications (including FTP and Telnet), and different information formats for files and documents including, for example, text, sound and graphics.

1.4 Hypermedia

The Web uses hypertext and hypermedia. Hypertext is a subset of hypermedia and refers to computer-based “documents” in which readers move from one place to another in a document, or to another document, in a non-linear manner. To do this, the Web uses a client-server architecture. Web servers enable users to access hypertext and hypermedia information through the Web and the users' computers. (The users' computers are referred to as client computers of the Web Server computers.) The clients send requests to the Web Servers, which react, search and respond. The Web allows client application software to request and receive hypermedia documents (including formatted text, audio, video and graphics) with hypertext link capabilities to other hypermedia documents, from a Web file server.

The Web, then, can be viewed as a collection of document files residing on Web host computers that are interconnected by hyperlinks using networking protocols, forming a virtual “web” that spans the Internet.

1.5 Uniform Resource Locators

A resource of the Internet is unambiguously identified by an Uniform Resource Locator (URL), which is a pointer to a particular resource at a particular location. A URL specifies the protocol used to access a server (e.g., HTTP, FTP, or the like), the name of the server, and the location of a file on that server.

1.6 Hyper Text Transfer Protocol

Each Web page that appears on client monitors of the Web may appear as a complex document that integrates, for example, text, images, sounds and animation. Each such page may also contain hyperlinks to other Web documents so that a user at a client computer using a mouse may click on icons and may activate hyperlink jumps to a new page (which is a graphical representation of another document file) on the same or a different Web server.

A Web server is a software program on a Web host computer that answers requests from Web clients, typically over the Internet. All Web servers use a language or protocol to communicate with Web clients which is called Hyper Text Transfer Protocol (“HTTP”). All types of data can be exchanged among Web servers and clients using this protocol, including Hyper Text Markup Language (“HTML”), graphics, sound and video. HTML describes the layout, contents and hyperlinks of the documents and pages.

When browsing, Web clients can perform several functions, including: converting user specified commands into HTTP GET requests, connecting to the appropriate Web server to get information, and waiting for a response. The response from the server can be the requested document or an error message.

After the document or an error message is returned to the client, the connection between the Web client and the Web server is closed.

The first version of HTTP is a stateless protocol. This means there is no continuous connection between each client and each server. The Web client using HTTP receives a response as HTML data or other data. This description applies to version 1.0 of HTTP protocol, while the newer version 1.1 break this barrier of stateless protocol by keeping the connection between the server and client alive under certain conditions.

1.7 Web Browser

After receipt, the Web client formats and presents the data or activates an ancillary application such a sound player to present the data. To do this, the server or the client determines the various types of data received. The Web Client is also referred to as the Web Browser, since it in fact browses documents retrieved from the Web Server.

1.8 Domain Names

The host or computers names (e.g., www.entreprise.com) are translated into numeric Internet addresses (e.g., 194.56.78.3), and vice versa, by using a method called DNS (“Domain Name Service”). DNS is supported by network-resident servers, also known as domain name servers or DNS servers.

1.9 Intranet

Some companies use the same mechanism as the Web to communicate inside their own corporation. In this case, this mechanism is called an “Intranet”. These companies use the same networking/transport protocols and locally based Web servers to provide access to vast amount of corporate information in a cohesive fashion. As this data may be private to the corporation, and because the members of the company still need to have access to public Web information, to avoid that people not belonging to the company can access to this private Intranet coming from the public Internet, they protect the access to their network by using a special equipment called a Firewall.

1.10 Firewall

A Firewall protects one or more computers from unauthorized Internet connections from external computers connected to the Internet. A Firewall is a network configuration, usually created by hardware and software that forms a boundary between networked computers within the Firewall from those outside the Firewall. The computers within the Firewall form a secure sub-network with internal access capabilities and shared resources not available from the outside computers.

Often, a single machine, on which the Firewall is resident, allows access to both internal and external computers. Since the Firewall computer directly interacts with the Internet, strict security measures against unwanted access from external computers are required.

A Firewall is commonly used to protect information such as electronic mail and data files within a physical building or organization site. A Firewall reduces the risk of intrusion by unauthorized people from the Internet. However, the same security measures can limit or require special software for those inside the Firewall who wish to access information on the outside. A Firewall can be configured using “Proxies” or “Socks” to designate access to information from each side of the Firewall.

1.11 Proxy Server

An HTTP Proxy is a special server that typically runs in conjunction with Firewall software and allows an access to the Internet from within a Firewall. In performing its functions, the Proxy Server: waits for a request (for example an HTTP request) from inside the Firewall, forwards the request to the remote server outside the Firewall, reads the response, and sends the response back to the client.

A single computer can run multiple servers, each server connection identified with a port number. A Proxy Server, like an HTTP Server or a FTP Server, occupies a port. Typically, a connection uses standardized port numbers for each protocol (for example, HTTP=80 and FTP=21). That is why an end user has to select a specific port number for each defined Proxy Server. Web Browsers usually let the end user set the host name and port number of the Proxy Servers in a customizable panel. Protocols such as HTTP, FTP, Gopher, WAIS, and Security can usually have designated Proxies. Proxies are generally preferred over Socks for their ability to perform caching, high-level logging, and access control, because they provide a specific connection for each network service protocol.

1.12 Background Publications Incorporated by Reference

Further explanation about the technical field presented in the above sections can be found in the following publications, incorporated herein by reference:

“TCP/IP Tutorial and Technical Overview”, by Martin W. Murhammer, Orcun Atakan, Stefan Bretz, Larry R. Pugh, Kazunari Suzuki, David H. Wood, International Technical Support Organization, October 1998, GG24-3376-05.

“Java Network Programming”, by Elliotte Rusty Harold, published by O'Reilly, February 1997.

“Internet in a Nutshell”, by Valerie Quercia, published by O'Reilly, October 1997.

“Building Internet Firewalls”, by Brent Chapman and Elizabeth Zwichky, published by O'Reilly, September 1995.

“IP Network Design Guide”, by Martin W. Murhammer, Kok-Keong Lee, Payam Motallebi, Paolo Borghi, Karl Wozabal, International Technical Support Organization, June 1999, SG24-2580-01.

“SNA and TCP/IP Integration”, by Jerzy Buczak, Karl Wozabal, Antonio Luca Castrichella, Heikki Lehikoinen, Maria Cristina Madureira, Tsutomu Masaoka, International Technical Support Organization, April 1999, SG24-5291-00.

Liz “Accessing the Internet”, by Eamon Murphy, Guy Denton, Peter Hutchinson, Debby Morrison, Pete Smith, Jim Spink, International Technical Support Organization, August 1995, SG24-2597-00.

“High-Speed Networking Technology: An Introductory Survey”, by Harry J. R. Dutton, International Technical Support Organization, June 1993, SG24-3816-01.

### SUMMARY OF THE INVENTION

The present invention provides an improved system and method for accessing from a client system connected to an IP (Internet Protocol) network (Internet or Intranet network), a server system connected to a circuit switched network, typically an ISDN (Integrated Services Digital Network) network or a PSTN network (Public Switched Telephone Network). The IP network and the circuit switched network, which are two independent networks, communicate through one or more Proxy servers.

According to one aspect of the present invention, a client/server application in a Proxy server permits access to servers connected to the IP network through non-permanent connections. The client/server application configures the Proxy server to receive from a client system a request for accessing information located in a server system. The request can include a source IP address and a destination IP address. The destination IP address of the server system is identified in the request. The server system can be connected to the Proxy server through a circuit-switching network. The identifier of the server system in the circuit-switching network referring to a first table is determined. The first table includes, for each server system identified by a destination IP address, a resource identifier in the circuit-switching network. A non-permanent connection with the server system, using the resource identifier associated with the server system, is established. The information requested by the client system from the server system is retrieved and sent to the client system.

### BRIEF DESCRIPTION OF THE DRAWINGS

The above and other objects, features and advantages of the invention will be better understood by reading the following detailed description of the invention in conjunction with the accompanying drawings, wherein:

FIG. 1 is a logical view of a prior art system for accessing the World Wide Web;

FIG. 2 is a physical view of the prior art system for accessing the World Wide Web of FIG. 1;

FIG. 3 shows the structure of an IP datagram;

FIG. 4 is a logical view of a client system accessing a server system connected to the Internet network through a non-permanent physical connection in accordance with the present invention;

FIG. 5 is a physical view of an end-user system accessing on one side a server system connected to the Internet network through a telephone network according to the present invention and on another side a server system directly connected to the Internet network according to prior art;

FIG. 6 shows the internal tables used by the Proxy server to establish a physical connection with a server system in accordance with the present invention; and

FIGS. 7a-b shows a flow chart of the method for accessing from an Internet network, a server system connected to a telephone network, in accordance with the present invention.

### DETAILED DESCRIPTION OF THE PRESENTLY PREFERRED EMBODIMENTS OF THE INVENTION

2.0 Access to the World Wide Web

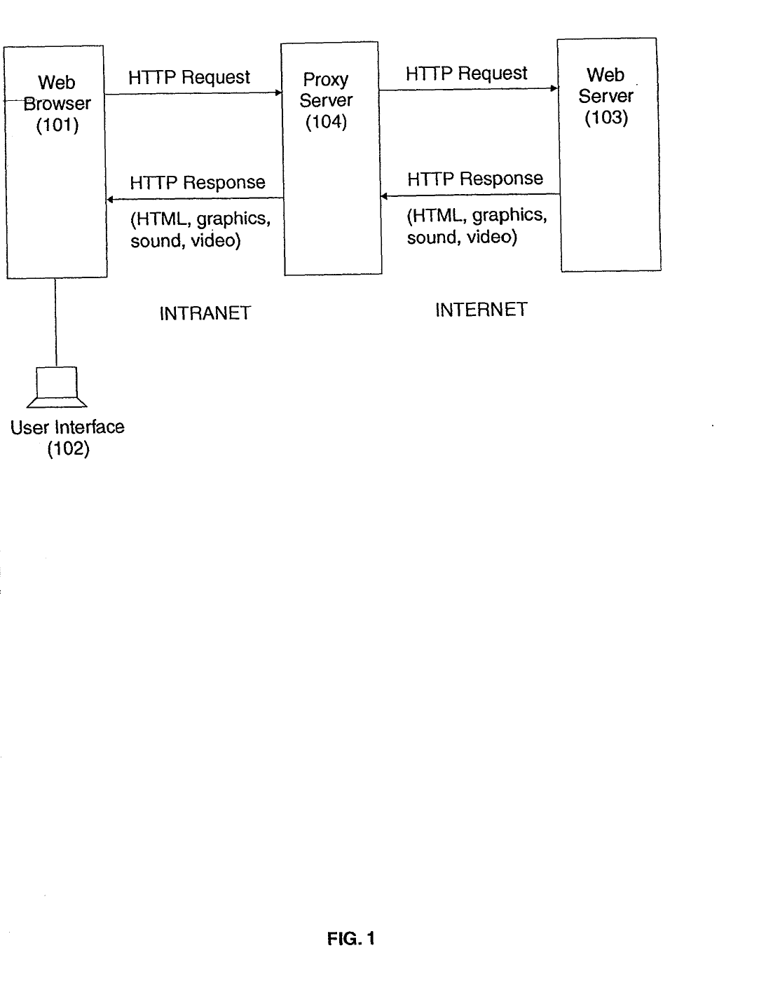

FIG. 1 shows a logical view of a prior art user system with a user interface (102) comprising a Web Browser (101) for accessing the World-Wide-Web (WWW). The WWW content is transferred using the HTTP protocol. HTTP requests and responses are exchanged between the Web Browser program (101) and a destination Web Server (103) containing the WWW information the user wants to access. The Proxy Server (104) between the Web Browser (101) and the Web Server (103) acts as an intermediary HTTP relay forwarding the HTTP requests and responses to their destination. The Web Browser program (101) makes an HTTP request to the Proxy Server (104) and the Proxy Server forwards the request to the destination Web Server (103). The flow in the reverse direction (HTTP response) again goes via the Proxy Server (104) to the Web Browser (101). In this way the Proxy Server can limit the traffic to authorized transactions according to its configuration (based on some defined security and access control policy). The Proxy Server hence protects the network where Web Browser is located.

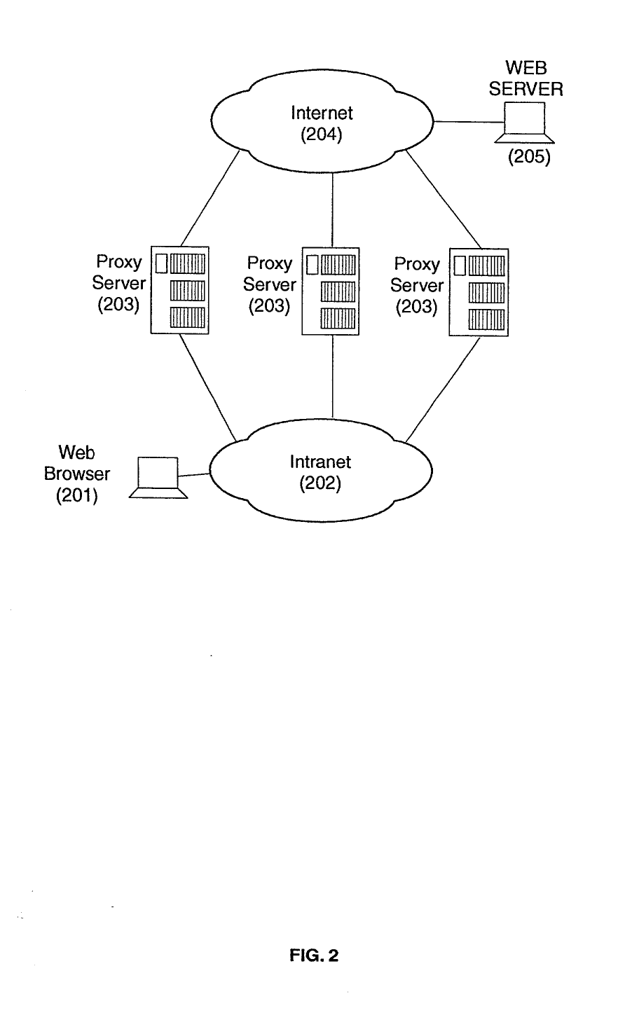

FIG. 2 is a physical view of the set-up logically described in FIG. 1. In this particular example, the Web Browser (201) runs on a system (workstation) connected to an Intranet (202) network. The Proxy Servers (203) protecting the Intranet connect both the (private) Intranet (202) and the (public) Internet (204). The destination Web Server (205) is also connected to the Internet. It is important to note that Proxy Servers attach two networks and hence act as intermediaries for communications between the two networks. Multiple Proxy Servers are often used in order to provide access robustness and load sharing.

3.0 IP Datagram

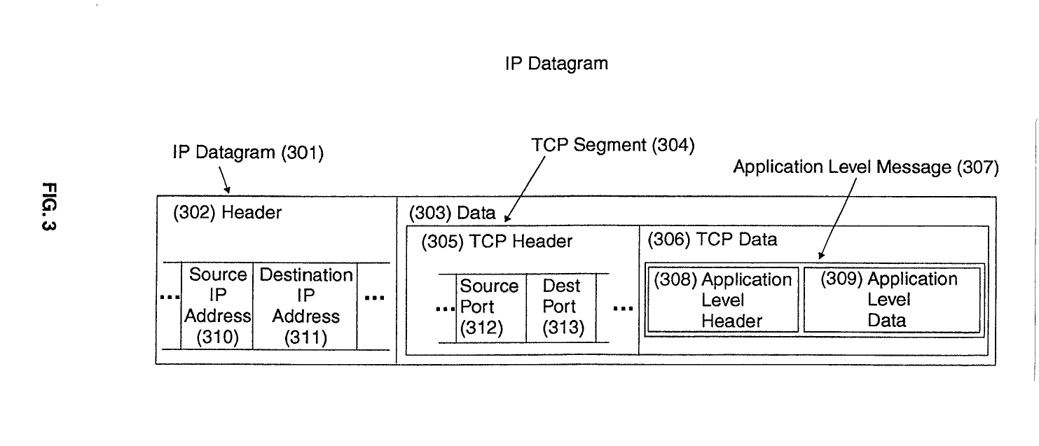

The transfer unit of a data packet in TCP/IP is called an IP Datagram. It is made up of a header containing information for IP protocol and data that is only relevant to the higher level protocol. FIG. 3 shows the format of an IP Datagram, in the environment described in FIGS. 1 and 2.

An IP Datagram (301) is a message exchanged between two computer systems across a TCP/IP network. An IP Datagram is divided in 2 parts: a Header (302), and Data (303).

The header (303) comprises fields such as: the Source IP Address (310) (the IP address of the computer which sends the IP Datagram), and the Destination IP Address (311) (the IP address of the computer which is the destination of the IP Datagram).

The IP Header is mainly used to route the IP Datagram to its final destination.

The IP Datagram Data (303) comprises the data sent by the originator to the destination computer system. The destination computer system processes this data. Since the TCP/IP protocol suite is organized in layers, the IP Datagram field comprises the message relevant to the higher level protocol (which is TCP in the environment related to the invention).

A TCP message is usually called TCP Segment (304).

A TCP Header (305) comprises fields such as the Source Port (312) and the Destination Port (313), which identify the application protocol (e.g. HTTP, FTP, Telnet, Socks) transported by TCP. This field is mainly used by the destination of the IP Datagram to determine which application must process the data transported by TCP.

The TCP Data field (306) comprises application data which are sent by the originator to the destination computer system. The destination computer system processes the data. Since the TCP/IP protocol suite is organized in layers, the TCP Data part contains the information relevant to the higher level protocol which is the Application level protocol (such as HTTP, FTP, Telnet, Socks).

The TCP Data field (306) of the IP Datagram contains an Application Level Message (307). This is, for example, a Socks message (for instance a “CONNECT” or a “BIND” message), an HTTP message, an FTP message, or a Telnet message. Depending on the Application level protocol, the Application Level Message (307) can also be split into two parts.

The Application Level Header (308) is the header relevant to the application protocol such as HTTP, FTP, Telnet.

The Application Level Data (309) is the data part which is processed by the application responsible of handling the Application Level protocol. This is usually the data that is directly relevant to the end user (for instance, data entered by an end user on his workstation).

4.0 Access to a Remote Server through a Non-Permanent Connection

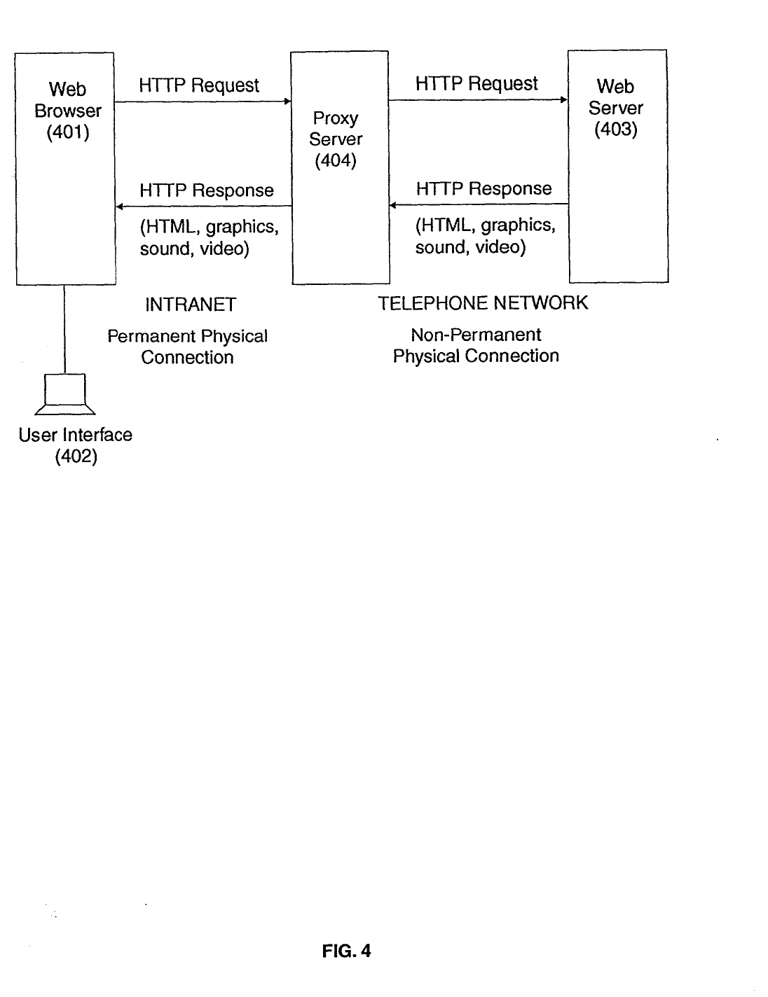

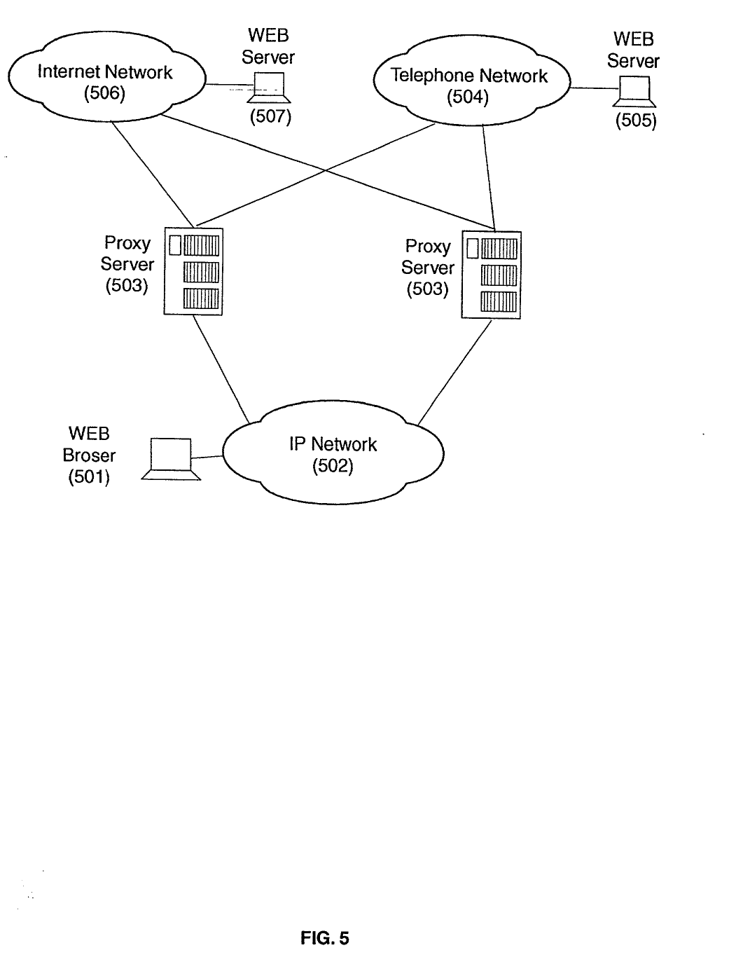

The object of the present invention is to allow the transmission of information between a client system (preferably a Web client) connected to an IP network (Internet or Intranet network) and a server system (preferably a Web server) connected to a circuit switched network (more particularly a telephone network) providing non-permanent connections. As shown in FIG. 4, a user system comprises a hardware workstation (402) and a software program (401) known as Web Browser program. The Web Browser program enables access to the World-Wide-Web. The communication protocol for transmitting information on the IP network is typically the HTTP protocol (HyperText Transfer Protocol). HTTP requests and responses are exchanged between the Web Browser program (401) and the destination Web server (403) using the services of a Proxy server (404). The Proxy server between the Web Browser (401) and the Web server (403) acts as an HTTP relay. The Web server is connected to the Proxy server by means of a non-permanent physical connection.

The Web Browser program (401) sends an HTTP request to the Proxy server (404) to access a Web page on a Web server (403) connected through a telephone network. In a particular embodiment of the invention, the Proxy server acts as a Web page cache.

If the requested page is available in the Proxy server cache, the Proxy server builds an HTTP response comprising the requested page and directly returns this HTTP response to the Web Browser.

If the Proxy server doesn't have the requested page in its cache, the requested page must be retrieved from the destination Web server (403). The Proxy server identifies the destination Web server IP address (310) in the header (302) of the request. A table (601) (called Proxy Phone Number table) is used by the Proxy server to determine the phone number of the destination Web server and establishes a non-permanent physical connection with this Web server through the telephone network. The Proxy Phone Number table can be stored locally in the Proxy server or can be remotely accessed. Once the communication is established, the HTTP request is forwarded to the destination Web server. The requested Web page is downloaded from the destination Web server into the Proxy server cache, which builds an HTTP response with this Web page. The response is then sent to the Web Browser (401). The non-permanent physical connection between the Proxy server and the Web server is released after a predefined period of time preferably at the expiration of a timer.

If the Proxy server does not receive another HTTP request from the Web Browser program before the expiration of this timer, then the non-permanent physical connection with the destination Web server is released.

If the Proxy server receives another HTTP request from the Web Browser before the expiration of this timer, then the non-permanent physical connection with the destination Web server is maintained and the timer is reset.

The Proxy server can have the ability to limit the data traffic to authorized Web servers according to a specific access authorization table (605) called Proxy Authorization table. This table will be described in detail below in another section.

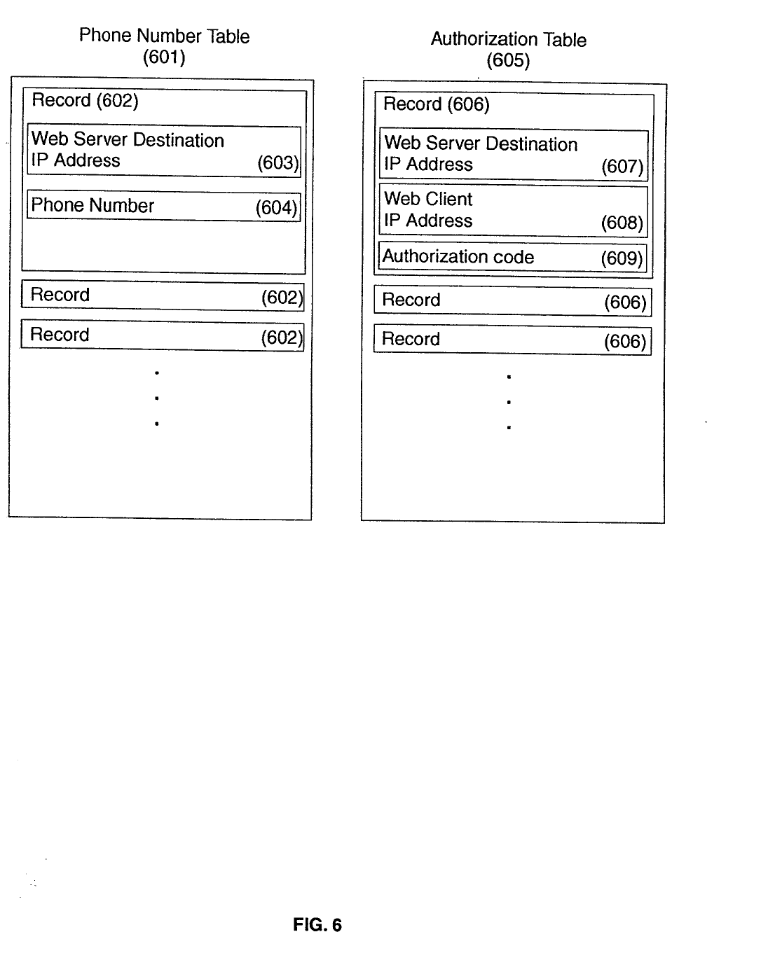

FIG. 5 is a physical view of the setup logically described in FIG. 4. The Web Browser (501) runs on a workstation connected to the IP network (502). The IP network (502), typically the Intranet, communicates with either the telephone network (504)(typically the PSTN network—Public Switched Telephone Network) or the Internet network (506) through one or a plurality of Proxy servers (503). When a Proxy server (503) receives an HTTP request from the Web Browser program (501), a non-permanent physical connection is established with the destination Web server (505) through the telephone network (504) according to the process described in the previous section. Then, the Proxy server (503) forwards the HTTP request to the destination Web server (505) which sends back the corresponding HTTP response.

5.0 Telephone Networks

Public and private telephone networks are connection oriented. Most of them use digital high-speed networking techniques based on Time Division Multiplexing (TDM). When the transmission bandwidth is very low in cost, it is not necessary to spend a lot of money on expensive packet switching nodes. Physical links can be shared using a simple time multiplexing scheme and the “inefficiency” in link utilization can be tolerated. Intelligent TDMs are needed to set up and clear down connections and to provide a multiplexed connection to the end user, but the cost of these may be considerably lower than the packet node alternative.

5.1 Integrated Services Digital Network

ISDN (Integrated Services Digital Network) is an example of telephone switched network providing non-permanent connections. ISDN describes and specifies a digital user interface to a public digital communications network. ISDN is a technology that allows the on-demand service of voice and non-voice transmission on a call-by-call basis. There are two forms of access (Basic Rate and Primary Rate) and the service offered is the connection of 64 kbps channels primarily on a switched service basis. There is also a low-rate “connectionless” packet switching ability available through a D channel. ISDN specifications can be summarized as follows:

Information (voice, text, data and picture) is transmitted using 64 kbps transport channels following the Pulse Code Modulation (PCM).

The Basic Rate Access (BRA) comprises two 64 kbps channels (B channel) for the transport of user information, and one 16 kbps channel (D channel) for signaling. For the connection of a PBX or data equipment, the Primary Rate Access (PRA) comprises 30×64 kbps B channels and one 64 kbps D channel (in the US 23B+1D).

One common interface fort he access to the network termination is specified. To this interface different end-user equipment such as phones and data terminals can be connected via a four-wire wiring.

Each access has its own phone number, regardless how of much end-user equipment is connected.

Signaling and transmission protocols are standardized.

5.1.1 ISDN Addressing

The ISDN address consists of two elements, the ISDN phone number with up to 15 digits (three digits more than in the analog network), and the ISDN subaddress with a maximum of 32 digits (for example for addressing a LAN server connected to the ISDN).

6.0 Proxy Tables

FIG. 6 depicts the different tables used by the Proxy server (503). These tables are locally stored or can be remotely accessed. Two tables are used: a Phone Number table (601) and an Authorization table (605). The Phone Number table comprises the telephone number of each Web server connected to the telephone network (504). More generally, this table comprises for each server connected to the circuit-switching network, its resource identifier. This resource identifier is used by the Proxy server to address (to call) the destination Web server and to establish a non-permanent connection with this Web server.

The Phone Number Table (601)(a flat file in a preferred embodiment) is created by the Network Administrator. The table comprises a list of records (602), one record per Web server. Each record comprises the following information: the destination IP address (603) of the Web server and the Phone number (604). The IP address field (603) comprises the IP address of the Web server (505) connected to the telephone network (504). The Phone Number field (604) comprises the phone number of the Web server (505) connected to the telephone network (504).

The Authorization table comprises a list of clients authorized to access Web servers connected to the Internet networks through the telephone network (504). The Authorization Table (605)(a flat file in a preferred embodiment) is created by the Network Administrator. The table contains a list of records (606), one record per Web server. Each record comprises the following information:

The destination IP address (607) of the Web server. This field comprises the IP address of the Web server (505) connected to the telephone network (504).

The source IP address (608) of the Web Client. This field comprises the IP address of the Web Client (501) connected to the IP network (502).

The Authorization code (609). This field comprises the authorization code of the Web client (501) connected to the IP network (502). For example, if this field contains a ‘0’ binary value, then the Web client (501) is not authorized to access the Web server (505). On the other hand, if this field contains a ‘1’ binary value, then the Web client (501) is authorized to access the Web server (505).

In an additional or alternate embodiment, the Authorization table comprises for each Web client, a list or authorized Web servers.

7.0 Performance and Security

The described operations can be enhanced to provide more performance and to offer a secure control access to the Web Server.

7.1 Proxy Cache

In the above description, when an HTTP request is received from a Web client (501), the Proxy server (503) generates a phone call to establish a non-permanent connection with the Web server (505). When the HTTP response is sent back to the Web client (501), the connection is released after expiration of a timer. The problem is that the next HTTP request will require the establishment of another phone call.

To improve this situation, the Proxy server (503) calls the Web server (505) from time to time without waiting for HTTP requests. After each phone call the Proxy server (503) downloads the main or the most requested Web pages from the Web server (505) and stores them into its memory (also called cache). When the Proxy server (503) receives an HTTP request from the Web Browser program (501), the Proxy server (503) first checks a if the requested page is available in its memory/cache.

If the requested page is in its cache, the Proxy server forwards immediately the page to the Web Browser program (501) at the origin of the HTTP request.

Otherwise, the Proxy server calls the Web server (505) as described earlier.

As the dial operation (connection establishment) introduces a period of latency period, the use, in the Proxy server, of a cache improves also the overall performance of the claimed method.

Furthermore, instead of updating cached pages at the request of the Proxy server, an alternate or complementary method is for the Web server (505) to update directly the cache of the Proxy server (503). When the Web server updates one of its page and if this page has to be cached in the Proxy server, the Web server establishes a non-permanent connection and sends the updated page to the Proxy server. In order to do that, the Proxy server informs the Web server of the list of pages that are cached with the date of the storage in the cache.

7.2 Authorization Table

In a preferred embodiment of the present invention, a security mechanism controls the access to the Web server (505). When the Proxy server (503) receives an IP datagram comprising an HTTP request from the client (501) (or Web Browser program), it identifies the IP source address in this IP datagram. As shown in FIG. 3, the IP datagram (301) is made of a Header field (302) and a Data field (303). The IP source address is located within the Header field (302). The Proxy server (503) compares the identified IP source address with a list of predefined authorized clients.

If the client is not in the list, then the Proxy server (503), returns a response “Request Rejected” to the client (501).

If the client is in the list then this client is authorized to access the Web server (505) as described earlier.

More secured authentication may be performed using the Secure Socket Layer (SSL) standard via Identifier (Id) and password.

It is important to control the access to the Web server (505) for at least two reasons:

1) the information stored in the Web server (505) can be restricted to particular clients; and

2) the connection to the Web server (505) through the telephone network (504) is not free of charge. The owner of the Proxy server, who pays the fee, may not want to offer this service to any clients.

8.0 Proxy Server Operation

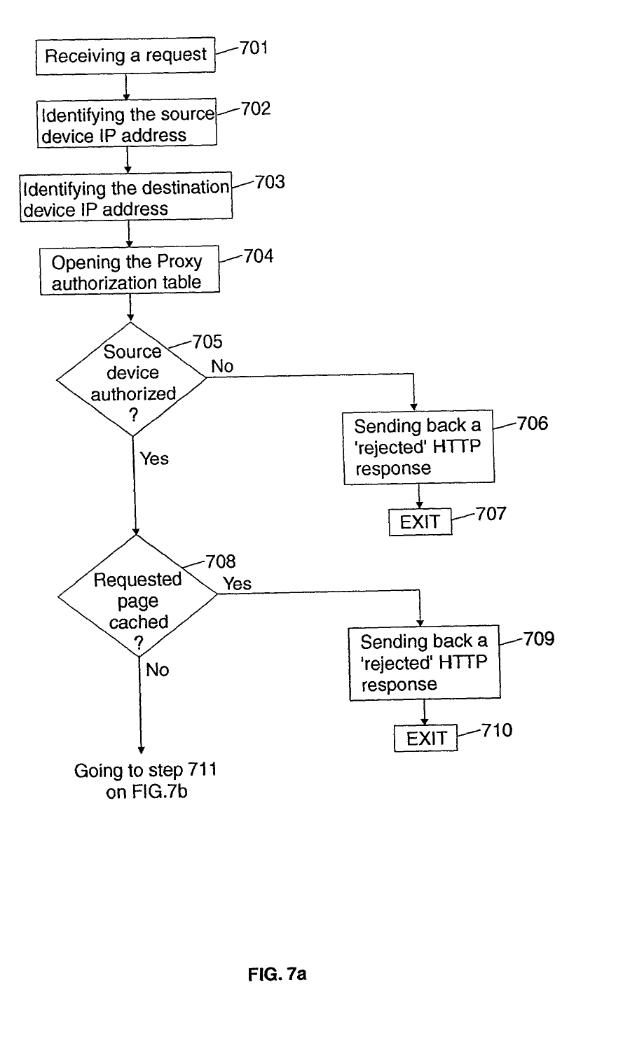

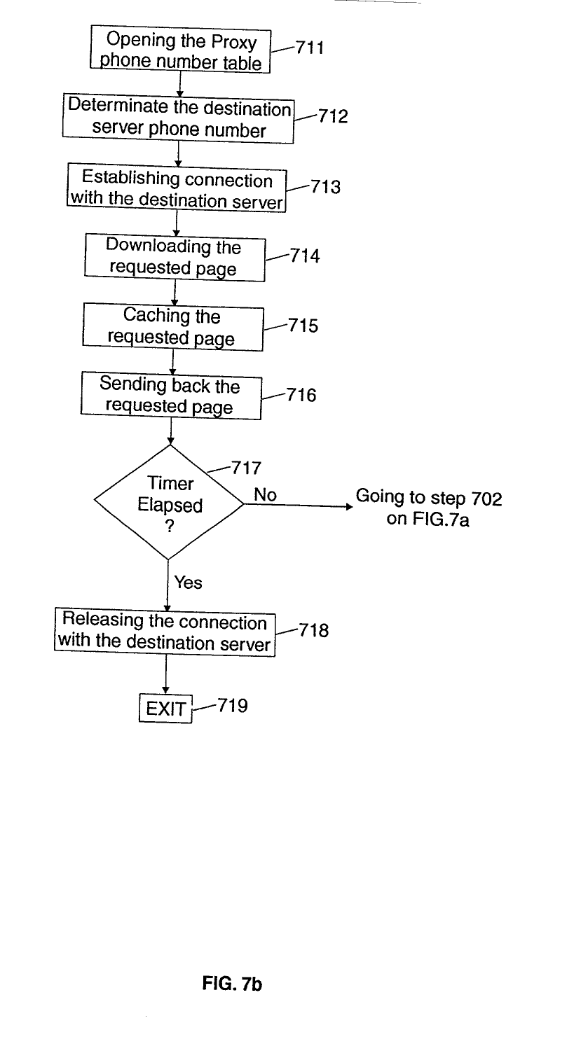

FIGS. 7a-b shows a flow chart of a method for use in a Proxy server, in accordance with the present invention. In step (701), a request for information is received by the Proxy server from a client system. More particularly, an IP Datagram comprising an HTTP request for a Web page can be received. In step (702), the Proxy server identifies in the request a source device, the source device being a client system connected to the IP network. In step (703), a destination device, given by the request, is identified. The destination device can be a server system connected to the IP network through a circuit-switching network or telephone network.

In step (704), the Authorization Table is accessed. Then, in step (705), a check is made to determine whether or not the client system (source device) is authorized to access the server system (destination device). If the source device is not authorized to access the destination device, step (706), the Proxy server responds by sending back an HTTP response “Request Rejected” to the source device and, step (707), exiting the routine. On the other hand, if the source device is authorized to access the destination device, the process continues with step (708).

In step (708), it is verified whether the requested page is locally cached or not. If the requested page is locally cached in the Proxy server, step (709), the requested page is returned to the source device and the routine is exited step (710). On the other hand, if the requested page is not locally cached in the Proxy server, the process goes on with step (711).

In step (711), the Phone Number Table is opened. In step (712), referring to the Phone Number Table, the Proxy server determines the phone number of destination server system. In step (713), a connection with the server system is established by dialing the server phone number.

In step (714), the requested page from the server system is downloaded. In step (715), the requested page is stored in the cache. Next, is step (716), the requested page is sent to the client system.

In step (717), a timer can be started by the Proxy server. If a new HTTP request is received before the timer elapses, the process continues with step (702). If the timer elapses without receiving another HTTP request, the process goes on with step (718).

In step (718), the connection between the Proxy server and the server system is released. In step (719), the routine is exited.

In another embodiment of the invention, the above-described method includes the further steps of: updating the most frequently requested pages cached in the Proxy server on a regular basis. This step can include establishing a connection with the server system, and then downloading and locally storing in the cache the most frequently requested pages. Alternatively, the step of updating can include receiving a call from the server system, and then receiving from the server system and locally storing in the cache the most frequently requested pages.

While specific embodiments of the present invention have been shown and described, it will apparent to those skilled in the art that the disclosed invention may be modified in numerous ways and may assume many embodiments other than those specifically set out and described above. Accordingly, the scope of the invention is indicated in the appended claims, and all changes that come within the meaning and range of equivalents are intended to be embraced therein.

What is claimed is:

1. A method, for use in a proxy server, of accessing from a client system connected to an Internet (IP) network, a server system connected to the proxy server by a non-permanent connection through a circuit-switching network, the method comprising:
receiving from the client system a request for accessing information located in the server system, the request comprising a source IP address and a destination IP address;
identifying in the request, a destination IP address of the server system, the server system being connected to the proxy server through the circuit-switching network;
determining the resource identifier of the server system in the circuit-switching network referring to a first table, the first table comprising, for each server system identified by a destination IP address, a resource identifier in the circuit-switching network;
establishing a non-permanent connection with the server system using the resource identifier associated with the server system;
retrieving the information requested by the client system from the server system; and
sending the requested information to the client system.

2. The method of claim 1, wherein the step of retrieving the information requested by the client system from the server system comprises:
storing the requested information in a cache.

3. The method of claim 2, further comprising:
updating the most frequently requested information cached in the proxy server by establishing a non-permanent connection with the server system, and retrieving and storing in the cache the most frequently requested information.

4. The method of claim 2, further comprising:
updating the most frequently requested information cached in the proxy server by receiving a call from the server system, and receiving from the server system and storing in the cache the most frequently requested information.

5. The method of claim 1, wherein the step of receiving from the client system the request for accessing information located in a server system comprises:
identifying in the request, the source IP address of the client system, the client system being connected to the proxy server through the IP network.

6. The method of claim 1, wherein the step of receiving from the client system the request for accessing information located in a server system comprises:
determining whether the client system is authorized to access the server system referring to a second table; and
sending to the client server a response indicating that the request is rejected if the client system is not authorized to access the server system.

7. The method of claim 1, wherein the step of receiving from the client system the request for accessing information located in a server system comprises:
determining whether the requested information is locally cached; and
sending the requested information to the client system if the requested information is locally cached.

8. The method of claim 1, wherein the step of retrieving the information requested by the client system from the server system comprises:
releasing the non-permanent connection established with the server system.

9. The method of claim 1, wherein the step of retrieving the information requested by the client system from the server system comprises:
starting a timer;
if a second request for information is received before the timer elapses, maintaining the non-permanent connection with the server system; and
if the timer elapses without receiving the second request for information, releasing the non-permanent connection with the server system.

10. The method of claim 1, wherein the client system is a web browser, the server system is a web server, the requested information includes one or more web pages and the request is a HTTP request.

11. The method of claim 1, wherein the circuit-switching network is a telephone network and the resource identifier is a phone number.

12. A proxy server, comprising:
means for receiving from a client system a request for accessing information located in a server system, the request comprising a source IP address and a destination IP address;
means for identifying in the request a destination IP address of the server system, the server system being connected to the proxy server through a circuit-switching network;
means for determining a resource identifier of the server system in the circuit-switching network referring to a first table, the first table comprising, for each server system identified by a destination IP address, a resource identifier in the circuit-switching network;
means for establishing a non-permanent connection with the server system using the resource identifier associated with the server system;
means for retrieving the information requested by the client system from the server system; and
means for sending the requested information to the client system.

13. The proxy server of claim 12, further comprising:
a cache for storing the requested information.

14. The proxy server of claim 13, further comprising:
means for updating the most frequently requested information cached in the proxy server by establishing a non-permanent connection with the server system, and retrieving and storing in the cache the most frequently requested information.

15. The proxy server of claim 13, further comprising:
means for updating the most frequently requested information cached in the proxy server by receiving a call from the server system, and receiving from the server system and storing in the cache the most frequently requested information.

16. The proxy server of claim 12, further comprising:
means for identifying in the request, the source IP address of the client system, the client system being connected to the proxy server through the IP network.

17. The proxy server of claim 12, further comprising:
means for determining whether the client system is authorized to access the server system referring to a second table; and
means for sending to the client server a response indicating that the request is rejected if the client system is not authorized to access the server system.

18. The proxy server of claim 12, further comprising:
means for determining whether the requested information is locally cached; and
means for sending the requested information to the client system if the requested information is locally cached.

19. The proxy server of claim 12, further comprising:
means for releasing the non-permanent connection established with the server system.

20. The proxy server of claim 12, further comprising:
a timer;
means for maintaining the non-permanent connection with the server system if a second request for information is received before the timer elapses; and
means for releasing the non-permanent connection with the server system if the timer elapses without receiving the second request for information.

21. The proxy server of claim 12, wherein the client system is a web browser, the server system is a web server, the requested information includes one or more web pages and the request is a HTTP request.

22. The proxy server of claim 12, wherein the circuit-switching network is a telephone network and the resource identifier is a phone number.

23. A computer-usable medium storing a computer program product comprising:
means for receiving from a client system a request for accessing information located in a server system, the request comprising a source IP address and a destination IP address;
means for identifying in the request a destination IP address of the server system, the server system being connected to the proxy server through a circuit-switching network;
means for determining a resource identifier of the server system in the circuit-switching network referring to a first table, the first table comprising, for each server system identified by a destination IP address, a resource identifier in the circuit-switching network;
means for establishing a non-permanent connection with the server system using the resource identifier associated with the server system;
means for retrieving the information requested by the client system from the server system; and
means for sending the requested information to the client system.

24. The computer-usable medium of claim 23, wherein the computer program product further comprises:
means for storing the requested information in a cache.

25. The computer-usable medium of claim 24, wherein the computer program product further comprises:
means for updating the most frequently requested information cached in the proxy server by establishing a non-permanent connection with the server system, and art retrieving and storing in the cache the most frequently requested information.

26. The computer-usable medium of claim 24, wherein the computer program product further comprises:
means for updating the most frequently requested information cached in the proxy server by receiving a call from the server system, and receiving from the server system and storing in the cache the most frequently requested information.

27. The computer-usable medium of claim 23, wherein the computer program product further comprises:
means for identifying in the request, the source IP address of the client system, the client system being connected to the proxy server through the IP network.

28. The computer-usable medium of claim 23, wherein the computer program product further comprises:
means for determining whether the client system is authorized to access the server system referring to a second table; and
means for sending to the client server a response indicating that the request is rejected if the client system is not authorized to access the server system.

29. The computer-usable medium of claim 23, wherein the computer program product further comprises:
means for determining whether the requested information is locally cached; and
means for sending the requested information to the client system if the requested information is locally cached.

30. The computer-usable medium of claim 23, wherein the computer program product further comprises:
means for releasing the non-permanent connection established with the server system.

31. The computer-usable medium of claim 23, wherein the computer program product further comprises:
means for starting a timer;
means for maintaining the non-permanent connection with the server system if a second request for information is received before the timer elapses; and
means for releasing the non-permanent connection with the server system if the timer elapses without receiving the second request for information.

32. The computer-usable medium of claim 23, wherein the client system is a web browser, the server system is a web server, the requested information includes one or more web pages and the request is a HTTP request.

33. The computer-usable medium of claim 23, wherein the circuit-switching network is a telephone network and the resource identifier is a phone number.
